(19) United States
(12) Patent Application Publication
(10) Pub. No.: US 2024/0177177 A1
(43) Pub. Date: May 30, 2024

(54) Concept for Capability Management

(71) Applicants: Yazan SIAM, Beaverton, OR (US); Tsippy MENDELSON, Modiin (IL); Vasuki CHILUKURI, Portland, OR (US)

(72) Inventors: Yazan SIAM, Beaverton, OR (US); Tsippy MENDELSON, Modiin (IL); Vasuki CHILUKURI, Portland, OR (US)

(21) Appl. No.: 18/391,709

(22) Filed: Dec. 21, 2023

Related U.S. Application Data
(60) Provisional application No. 63/518,606, filed on Aug. 10, 2023.

(51) Int. Cl. G06Q 30/018

(52) U.S. Cl. CPC G06Q 30/018

(57) ABSTRACT

Some aspects of the present disclosure relate to an apparatus for a computer system, the apparatus comprising interface circuitry, machine-readable instructions, and processor circuitry to execute the machine-readable instructions to obtain information on a profile of specified capabilities of the computer system, compare capabilities of the computer system with the profile of specified capabilities, and provide information on the computer system satisfying the profile of specified capabilities if the capabilities of the computer system satisfy the profile of specified capabilities.

### BACKGROUND

On computing platforms, such as the Intel® vPro® platform, it may be considered difficult to determine which capabilities exist on which platform models across OEMs (Original Equipment Manufacturers). As a result, a broad usage of the capabilities of the respective platforms has slowed or is delayed, as IT (Information Technology) shops and users are unaware of which capabilities their respective platforms support.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a computer system, and of a computer system comprising such an apparatus or device;

FIG. 1b shows a flow chart of an example of a method for a computer system;

FIG. 2 shows a schematic diagram of a manageability engine; and

FIG. 3 shows a flow chart of a provisioning of a platform.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

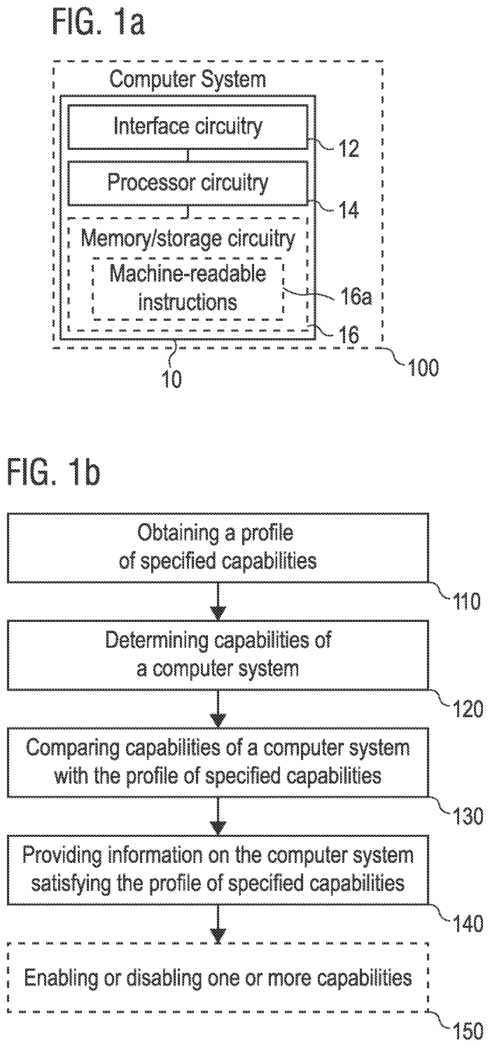

FIG. 1a shows a schematic diagram of an example of an apparatus 10 or device 10 for a computer system 100, and of a computer system 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processor circuitry 14, and (optional) memory/storage circuitry 16. For example, the processor circuitry 14 may be coupled with the interface circuitry 12 and/or with the memory/storage circuitry 16. For example, the processor circuitry 14 may provide the functionality of the apparatus, in conjunction with the interface circuitry 12 (for communicating with other entities inside or outside the computing device 100, such as a remote entity), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device may comprise the machine-readable instructions 16a, e.g., within the memory or storage circuitry 16 or means for storing information 16.

The processor circuitry 14 or means for processing 14 is to obtain a profile of specified capabilities of the computer system. The processor circuitry 14 or means for processing 14 is to compare capabilities supported by the computer system with the profile of specified capabilities. The processor circuitry 14 or means for processing 14 is to provide information on the computer system satisfying the profile of specified capabilities if the capabilities supported by the computer system satisfy the profile of specified capabilities.

FIG. 1b shows a flow chart of an example of a corresponding method for the computer system 100. The method comprises obtaining 110 the profile of specified capabilities of the computer system. The method comprises determining 120 the capabilities supported by the computer system. The method comprises comparing 130 the capabilities supported by the computer system with the profile of specified capabilities. The method comprises providing 140 the information on the computer system satisfying the profile of specified capabilities if the capabilities supported by the computer system satisfy the profile of specified capabilities. For example, the method may be performed by the computer system 100, e.g., by the apparatus 10 or device 10 of the computer system 100.

In the following, the features of the apparatus 10, device 10, computer system 100, method, and of a corresponding computer program will be discussed in more detail with reference to the apparatus 10. Accordingly, features introduced in connection with the apparatus 10 may likewise be included in the corresponding device 10, computer system 100, method and computer program.

Various examples of the present disclosure relate to techniques for ensuring the correct declaration of capabilities of computer systems, e.g., to enable third parties to verify that a specific computer system adheres to a profile of specified capabilities (e.g., to a branded profile of specified capabilities).

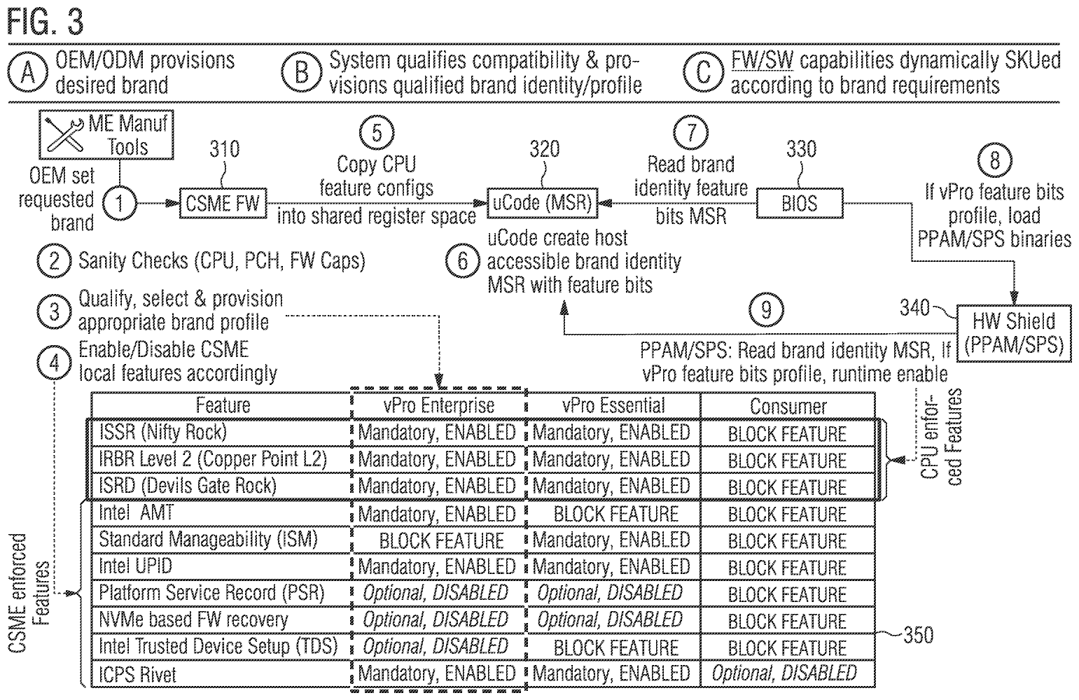

Modern computer systems feature a large number of different capabilities. Such capabilities may include at least one of a capability related to a trusted execution environment (e.g., presence or features of a trusted execution environment), a capability related to remote management of the computer system (e.g., presence or features of a remote management engine/firmware), a capability related to trusted device setup (e.g., whether the computer system supports trusted device setup), and a capability related to computer system security (e.g., which security feature(s) are supported by the computer system). For example, in FIG. 3, table 350 comprises a list of examples of capabilities supported by three different computing platform brands (“vPro Enterprise”, “vPro Essential” and “Consumer”). In FIG. 3, the capabilities ISSR (Intel® System Security Report, a capability related to computer system security provided as part of the Nifty Rock security measures), IRBR (Intel® Run-Time BIOS Resilience) Level 2, a capability related to computer system security provided as part of Copper Point Level 2, Intel® System Resource Defense, a capability related to computer system security provided as part of Devil's Gate Rock, AMT (Active Management Technology), a remote management capability, ISM (Intel Standard Manageability), a capability related to remote management, UPID (Unique Platform ID), a remote attestation feature, Platform Service Record, a persistent logging capability, NVMe-based firmware recovery a capability related to computer system security and resiliency, Trusted Device Setup, a capability related to trusted device setup, and ICPS (Intel® Connectivity Performance Suite) Rivet, a capability related to networking are shown.

Many capabilities have been developed over the years, and their number has thus steadily increased, as computer systems tend to support older capabilities to ensure backwards compatibility. However, some capabilities are based on support by a central processing unit (CPU) of the computer system, some capabilities are based on presence of specific hardware modules (such as a Trusted Platform Module (TPM), a Trusted Execution Environment (TEE), a remote management engine/firmware etc.). Therefore, even in the same line of computer systems, different capabilities may be supported, which makes it hard for buyers to identify the best computer system for their need.

To aid in the selection of computer systems, platform vendors, such as Intel®, have created branded platform profiles, which generally specify a minimum selection of capabilities that have to be supported to match the branded platform profile. However, as capabilities can vary among CPUs of the same generation or between generations of chips, the capabilities of the same line of computer systems can vary, which may result in some computer systems of the line being in accordance with the branded platform profile while other computer systems of the line being in violation of the branded platform profile. Due to such mismatches, computer systems may be advertised to provide the specified minimum capabilities of the branded platform profile, while some computer systems, unbeknownst to the buyer, may lack the respective capabilities.

The present disclosure provides a mechanism for verifying, on a per-computer system basis, whether a specific computer system is in accordance with a specified profile of specified capabilities (e.g., a branded profile of capabilities, or computing platform brand), enabling a buyer to verify that the bought computer system supports the advertised capabilities.

The proposed concept starts with provisioning the computer system with the profile of specified capabilities, e.g., according to the branded profile of capabilities, or computing platform brand. For example, the computer system may be provisioned to the computer system during manufacturing of the computer system. For example, the profile of specified capabilities may be assigned to the computer system, during manufacturing of the computer system, by a vendor of the computer system. Thus, the profile of specified capabilities may be obtained during manufacturing. For example, the computer system may be at least partially booted during manufacturing, and the profile of specified capabilities may be transmitted to the computer system or read by the computer system from a storage circuitry, during manufacturing. For example, a firmware of the computer system (e.g., the Unified Extensible Firmware Interface, UEFI), may be provisioned with, and thus comprise, the profile of specified capabilities.

As outlined above, the proposed concept is particularly relevant with respect to branded profiles of specified capabilities. Thus, the profile of specified capabilities specifies the capabilities required by a computer system to be allowed to advertise adherence with a computing platform brand. Adherence to the computing platform brand may be verified and advertised if the computer system is based on the computing platform and supports the minimum set of capabilities specified by the computing platform brand. Accordingly, the profile of specified capabilities may be specified for a computing platform, with the computer system being based on the computing platform if the capabilities supported by the computer system satisfy the profile of specified capabilities.

As the capabilities supported by the computer system are later compared to the actual capabilities supported by the computer system, the processor circuitry may determine the capabilities supported by the computer system. Accordingly, as further shown in FIG. 1b, the method comprises determining 120 the capabilities supported by the computer system. This can be done, during the manufacturing process (e.g., when the computer system is booted during the manufacturing process), by reading out the capabilities supported by the CPU of the computer system and/or the presence of and/or capabilities supported by one or more further hardware modules (e.g., TPM, TEE, remote management engine etc.).

The processor circuitry then compares capabilities supported by the computer system with the profile of specified capabilities. For example, the profile of specified capabilities may specify a plurality of capabilities that have to be supported to adhere to the profile of specified capabilities. The processor circuitry may, for each of the plurality of capabilities that have to be supported to adhere to the profile of specified capabilities, check whether the computer system has/supports the respective capability. If all of the capabilities that have to be supported to adhere to the profile of specified capabilities are supported by the computer system, and thus the computer system satisfies the profile of specified capabilities, the comparison may yield a positive result. If at least one of the plurality of capabilities that have to be supported to adhere to the profile of specified capabilities is not supported by the computer system, the comparison may yield a negative result. In this case, the computer system does not satisfy the profile of specified capabilities.

Based on the comparison, the processor circuitry provides the information on the computer system satisfying the profile of specified capabilities. For example, if the capabilities supported by the computer system satisfy the profile of specified capabilities, the information on the computer system satisfying the profile of specified capabilities may be provided or may be provided with a positive result. If the capabilities supported by the computer system do not satisfy the profile of specified capabilities, the information on the computer system satisfying the profile of specified capabilities may not be provided or may be provided with a negative result.

The information on the computer system satisfying the profile of specified capabilities may be provided in various ways. For example, the processor circuitry may store the information on the computer system satisfying the profile of specified capabilities on a storage circuitry of the computer system or on a removable storage circuitry, such as a flash drive. Alternatively, or additionally, the information on the computer system satisfying the profile of specified capabilities may be stored in a register of the processor (e.g., CPU) of the computer system. For example, the processor circuitry may provide the information on the computer system satisfying the profile of specified capabilities via a model-specific register of the processor of the computer system, e.g., by storing the information on the computer system satisfying the profile of specified capabilities in the model-specific register.

In some examples, the information on the computer system satisfying the profile of specified capabilities may be provided in a cryptographically secured manner. For example, the processor circuitry may provide the information on the computer system satisfying the profile of specified capabilities via a cryptographic certificate attesting that the computer system satisfies the profile of specified capabilities. This cryptographic certificate may be based on a hardware root of trust that is used to attest the identity and trustworthiness of the computer system. A hardware root of trust is a foundational element in computer systems architecture, providing a secure starting point for executing operations. It comprises one or more hardware modules that are inherently trusted and whose trustworthiness is not derived from a higher authority. Due to this innate trust, these hardware components can be used to verify the integrity and authenticity of critical system processes and software. For example, a hardware root of trust can be used for the purpose of attestation. For instance, a TPM (Trusted Platform Module, a part of the hardware root of trust) can sign a piece of data with its private key, which corresponds to a certificate that represents the TPM's identity. This signed data can be used to prove to external entities that the system is in a known good state. In the present context, the information on the computer system satisfying the profile of specified capabilities may be signed using a private key of the TPM and then used for the purpose of remote attestation. Accordingly, the certificate attesting that the computer system satisfies the profile of specified capabilities may be a certificate of a hardware root of trust certificate chain of the computer system. The processor circuitry may provide the cryptographic certificate to a remote entity, e.g., as part of a remote attestation process, or to verify that the computer system satisfies the profile of specified capabilities.

In some examples, the profile of specified capabilities may not only be used for the purpose of determining, whether a computer system adheres to the profile, and thus the computing platform brand, but also to selectively enable/disable features depending on the profile of specified capabilities (i.e., in adherence to the brand). In FIG. 3, table 350 shows capabilities that are either mandatory for a computing platform brand, optional for a computing platform brand (and disabled by default) or blocked. Depending on the profile of specified capabilities, the capabilities of the computer system may be selectively enabled or disabled (e.g., disabled, if they are optional, and blocked if they are blocked according to the computing platform brand). In other words, the processor circuitry may enable or disable one or more capabilities of the computer system according to the profile of capabilities. Accordingly, as further shown in FIG. 1, the method may comprise enabling or disabling 150 one or more capabilities of the computer system according to the profile of capabilities. This may be done during the manufacturing process, e.g., when the information on the computer system satisfying the profile of specified capabilities is initially determined. For example, the processor circuitry may obtain the profile of specified capabilities during a manufacturing process of manufacturing the computer system and enable or disable the one or more capabilities of the computer system according to the profile of capabilities during the manufacturing process of manufacturing the computer system.

The capabilities being enabled or disabled may include various capabilities of the computer system. For example, as already discussed earlier with reference to FIG. 3, table 350, the one or more capabilities may include at least one of a capability related to a trusted execution environment, a capability related to remote management of the computer system, a capability related to trusted device setup, and a capability related to computer system security. Such capabilities may be implemented by various components of the computer system, e.g., by the processor, by a firmware, or even by a driver or application software. Accordingly, the one or more capabilities may be enabled and/or disabled in these places. For example, the processor circuitry may enable or disable one or more capabilities of a processor of the computer system according to the profile of capabilities. This can be done by storing a setting (or setting a fuse) of the processor. For example, the processor circuitry may enable or disable the one or more capabilities of the processor via a microcode of the processor (which is generally reversible). Additionally, or alternatively, the processor circuitry may enable or disable one or more capabilities of a firmware (e.g., of the UEFI, of a BIOS (Basic Input Output system), of a remote management firmware or a security firmware) of the computer system according to the profile of capabilities. Additionally, or alternatively, the processor circuitry may enable or disable one or more capabilities of a driver or application software according to the profile of capabilities.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be one of a desktop computer system, a workstation computer system, a server computer system, a mobile computer system, a laptop computer system, a tablet computer system, an Internet of Things computer system, and a smartphone computer system.

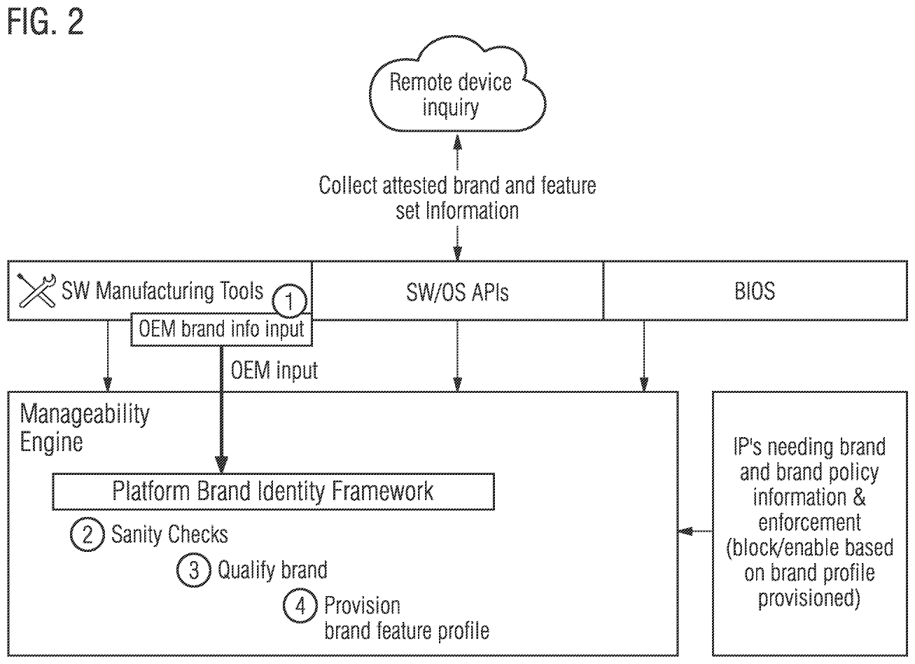

More details and aspects of the apparatus 10, device 10, computer system 100, method and computer program are mentioned in connection with the proposed concept, or one or more examples described above or below (e.g., FIG. 2 or 3). The apparatus 10, device 10, computer system 100, method and computer program may comprise one or more additional optional features corresponding to one or more aspects of the proposed concept, or one or more examples described above or below.

Various examples of the present disclosure relate to a concept for platform brand identity and capability management.

System capabilities of computing platforms, e.g., of Intel® computing platforms, are often enabled through long standing co-engineering process with OEMs/ODMs (Original Equipment Manufacturers/Original Device Manufacturers), where OEMs are expected to follow brand capability specifications of the platform vendor, by configuring individual capabilities in the system during the manufacturing process, to match the brand expectations of the platform vendor and the respective physical brand sticker applied to the device. This is a trust-based model between the platform vendor and OEM/ODM. The platform vendor is dependent on the OEM/ODM to follow the platform vendor's guidance for the newly built devices to meet the platform vendor's brand expectations.

Another vector in the current model is that brand exclusive capabilities of the platform vendor are expected to be brand aware but, they do not have visibility into system's intended brand. Therefore, each capability has created its own custom inference mechanism to understand the resident platform brand and SKU (Stock-Keeping Unit) their respective stacks accordingly (e.g., if the AMT (Active Management Technology) is enabled, the computing platform is vPro, if a system has a NIC (Network Interface Card), the system is a vPro system etc.). Custom inferences may be unable to match platform brand with 100% accuracy and may fail to provide the desired capability experience for the end customer. With multi-use processor SKUs, hardware components and firmware images, there is no one inference rule in the current architecture that fulfills all needs. In effect, disaggregated management of brand and brand-specific capability policies, along with the dependency on the OEM to configure individual capabilities to meet brand expectations, may result in inconsistent capability delivery and brand experience across OEMs.

The proposed concept provides a centralized brand policy management engine which may perform one or more of the following tasks: enforce brand and capabilities, communicate brand and capabilities, provides cryptographic attestation of brand and capabilities, provide an extensible framework for Intel to add new capabilities and brands, and simplify system configuration for the OEMs.

Various examples of the present disclosure may digitize brand and capabilities and provide a consistent platform vendor brand experience across OEMs by bringing clarity and predictability to the platform and capabilities being delivered and simplify and streamline system configuration in manufacturing.

For example, starting with a certain generation of a platform, the OEM/ODM may provision the platform with the desired brand (e.g., the profile of specified capabilities, indicating one or more guaranteed capabilities, and, optionally, one or more optional capabilities), e.g., utilizing the Intel® CSME (Converged Security and Management Engine) manufacturing tools. A manageability engine (e.g., Intel® CSME) may qualify the system for brand compatibility by computing the CPU and PCH (Platform Controller Hub)/SOC (System-on-Chip) capabilities, the FW (firmware) capabilities, and the capabilities enabled by the OEM against the OEM desired brand. The manageability engine (e.g., CSME) may assign a brand identity to the platform and bring into effect the appropriate embedded brand profile that defines and enforces brand qualified capabilities. For example, the manageability engine (e.g., CSME) may include the brand identity and brand qualified capabilities (i.e., the information on the computer system satisfying the profile of specified capabilities) in a certificate (e.g., the cryptographic certificate), such as the Intel® UPID (Unique Platform Identifier) IDevID (secure device identity) certificate, providing a cryptographically signed proof of the authenticity of the brand as manufactured by the OEM. Platform capabilities including CSME features, CPU (Central Processing Unit) features and host SW (software) may utilize manageability engine (e.g., CSME) providing standard interfaces to infer the brand and brand capability policies and make appropriate run decisions. The proposed concept and framework may simplify system configuration and eliminate generation over generation configuration complexity in manufacturing by moving the brand capability and associated policy variability management to the manageability engine (e.g., CSME)

FIG. 2 shows a schematic diagram of a manageability engine. Software manufacturing tools are used, at (1) to provide the OEM brand info input to the manageability engine. Intel® IPs (Intellectual Property) needing brand and brand policy information & enforcement (block/enable based on brand profile provisioned) are also provided as input to the manageability engine. The manageability engine performs one or more of the following tasks: (2) perform sanity checks, (3) qualify brand, and (4) provision brand feature profile. Via Software/operating system (SW/OS) APIs (Application Programming Interfaces), attested brand and feature set information may be obtained from the manageability engine and provided in response to a remote device inquiry.

FIG. 3 shows a flow chart of a provisioning of a platform. In FIG. 3, three aspects are shown—(A) the OEM/ODM provisioning the desired brand, (B) the system qualifying compatibility and provisioning a qualified brand identity/profile, and (C) the FW/SW capabilities dynamically being SKUed according to brand requirements. Using manageability engine manufacturing tools, at (1), the OEM sets the requested brand at the CSME firmware 310. At (2), the manageability engine performs sanity checks (CPU, PCH, FW Caps). At (3), the system qualifies, selects & provisions the appropriate brand profile (e.g., according to table 350). At (4), the system enable/disables CSME local features accordingly (i.e., according to the qualified brand). At (5), CPU feature configurations are copied into a shared register space (to be read by microcode, e.g., a model-specific register (MSR)). At (6), the microcode 320 creates a host-accessible model-specific register with feature bits (representing the information on the computer system satisfying the profile of specified capabilities). At (7), the BIOS (Basic Input/Output System) 330 reads the brand identity features bits MSR. At (8), if it includes a vPro feature bits profile, the BIOS loads PPAM (Platform Properties Assessment Module)/SPS (Server Platform Services) binaries for the hardware shield 340 (that includes the PPAM/SPS). At (9), the PPAM/SPS reads the brand identity MSR, and if it is a vPro feature bits profile, runtime enable features of the platform (depending on the brand profile).

More details and aspects of the concept for platform brand identity and capability management are mentioned in connection with the proposed concept, or one or more examples described above or below (e.g., FIG. 1a to 1b). The concept for platform brand identity and capability management may comprise one or more additional optional features corresponding to one or more aspects of the proposed concept, or one or more examples described above or below.

In the following, some examples of the proposed concept are presented:

An example (e.g., example 1) relates to an apparatus (10) for a computer system (100), the apparatus comprising interface circuitry (12), machine-readable instructions, and processor circuitry (14) to execute the machine-readable instructions to obtain a profile of specified capabilities of the computer system, compare capabilities supported by the computer system with the profile of specified capabilities, and provide information on the computer system satisfying the profile of specified capabilities if the capabilities supported by the computer system satisfy the profile of specified capabilities.

Another example (e.g., example 2) relates to a previous example (e.g., example 1) or to any other example, further comprising that the profile of specified capabilities is assigned to the computer system, during manufacturing of the computer system, by a vendor of the computer system.

Another example (e.g., example 3) relates to a previous example (e.g., one of the examples 1 or 2) or to any other example, further comprising that the profile of specified capabilities is specified for a computing platform, with the computer system being based on the computing platform if the capabilities supported by the computer system satisfy the profile of specified capabilities.

Another example (e.g., example 4) relates to a previous example (e.g., one of the examples 1 to 3) or to any other example, further comprising that the profile of specified capabilities specifies the capabilities required by a computer system to be allowed to advertise adherence with a computing platform brand.

Another example (e.g., example 5) relates to a previous example (e.g., one of the examples 1 to 4) or to any other example, further comprising that the processor circuitry is to execute the machine-readable instructions to enable or disable one or more capabilities of the computer system according to the profile of capabilities.

Another example (e.g., example 6) relates to a previous example (e.g., example 5) or to any other example, further comprising that the processor circuitry is to execute the machine-readable instructions to enable or disable one or more capabilities of a processor of the computer system according to the profile of capabilities.

Another example (e.g., example 7) relates to a previous example (e.g., example 6) or to any other example, further comprising that the processor circuitry is to execute the machine-readable instructions to enable or disable the one or more capabilities of the processor via a microcode of the processor.

Another example (e.g., example 8) relates to a previous example (e.g., one of the examples 5 to 7) or to any other example, further comprising that the processor circuitry is to execute the machine-readable instructions to enable or disable one or more capabilities of a firmware of the computer system according to the profile of capabilities.

Another example (e.g., example 9) relates to a previous example (e.g., one of the examples 5 to 7) or to any other example, further comprising that the processor circuitry is to execute the machine-readable instructions to enable or disable one or more capabilities of a driver or application software according to the profile of capabilities.

Another example (e.g., example 10) relates to a previous example (e.g., one of the examples 5 to 9) or to any other example, further comprising that the processor circuitry is to execute the machine-readable instructions to obtain the profile of specified capabilities during a manufacturing process of manufacturing the computer system, and to enable or disable the one or more capabilities of the computer system according to the profile of capabilities during the manufacturing process of manufacturing the computer system.

Another example (e.g., example 11) relates to a previous example (e.g., one of the examples 5 to 10) or to any other example, further comprising that the one or more capabilities include at least one of a capability related to a trusted execution environment, a capability related to remote management of the computer system, a capability related to trusted device setup, and a capability related to computer system security.

Another example (e.g., example 12) relates to a previous example (e.g., one of the examples 1 to 11) or to any other example, further comprising that the processor circuitry is to execute the machine-readable instructions to provide the information on the computer system satisfying the profile of specified capabilities via a model-specific register of a processor of the computer system.

Another example (e.g., example 13) relates to a previous example (e.g., one of the examples 1 to 12) or to any other example, further comprising that the processor circuitry is to execute the machine-readable instructions to provide the information on the computer system satisfying the profile of specified capabilities via a cryptographic certificate attesting that the computer system satisfies the profile of specified capabilities.

Another example (e.g., example 14) relates to a previous example (e.g., example 13) or to any other example, further comprising that the certificate is a certificate of a hardware root of trust certificate chain.

Another example (e.g., example 15) relates to a previous example (e.g., one of the examples 13 or 14) or to any other example, further comprising that the processor circuitry is to execute the machine-readable instructions to provide the cryptographic certificate to a remote entity.

An example (e.g., example 16) relates to an apparatus (10) for a computer system (100), the apparatus comprising processor circuitry (14) configured to obtain a profile of specified capabilities of the computer system, compare capabilities supported by the computer system with the profile of specified capabilities, and provide information on the computer system satisfying the profile of specified capabilities if the capabilities supported by the computer system satisfy the profile of specified capabilities.

An example (e.g., example 17) relates to a device (10) for a computer system (100), the device comprising means for processing (14) for obtaining a profile of specified capabilities of the computer system, comparing capabilities supported by the computer system with the profile of specified capabilities, and providing information on the computer system satisfying the profile of specified capabilities if the capabilities supported by the computer system satisfy the profile of specified capabilities.

Another example (e.g., example 18) relates to a computer system (100) comprising the apparatus (10) or device (10) according to one of the examples 1 to 17 (or according to any other example).

An example (e.g., example 19) relates to a method for a computer system (100), the method comprising obtaining (110) a profile of specified capabilities of the computer system, comparing (130) capabilities supported by the computer system with the profile of specified capabilities, and providing (140) information on the computer system satisfying the profile of specified capabilities if the capabilities supported by the computer system satisfy the profile of specified capabilities.

Another example (e.g., example 20) relates to a previous example (e.g., example 19) or to any other example, further comprising that the profile of specified capabilities is assigned to the computer system, during manufacturing of the computer system, by a vendor of the computer system.

Another example (e.g., example 21) relates to a previous example (e.g., one of the examples 19 or 20) or to any other example, further comprising that the profile of specified capabilities is specified for a computing platform, with the computer system being based on the computing platform if the capabilities supported by the computer system satisfy the profile of specified capabilities.

Another example (e.g., example 22) relates to a previous example (e.g., one of the examples 19 to 21) or to any other example, further comprising that the profile of specified capabilities specifies the capabilities required by a computer system to be allowed to advertise adherence with a computing platform brand.

Another example (e.g., example 23) relates to a previous example (e.g., one of the examples 19 to 22) or to any other example, further comprising that the method comprises enabling or disabling (150) one or more capabilities of the computer system according to the profile of capabilities.

Another example (e.g., example 24) relates to a previous example (e.g., example 23) or to any other example, further comprising that the method comprises enabling or disabling (150) one or more capabilities of a processor of the computer system according to the profile of capabilities.

Another example (e.g., example 25) relates to a previous example (e.g., example 24) or to any other example, further comprising that the method comprises enabling or disabling (150) the one or more capabilities of the processor via a microcode of the processor.

Another example (e.g., example 26) relates to a previous example (e.g., one of the examples 23 to 25) or to any other example, further comprising that the method comprises enabling or disabling (150) one or more capabilities of a firmware of the computer system according to the profile of capabilities.

Another example (e.g., example 27) relates to a previous example (e.g., one of the examples 23 to 25) or to any other example, further comprising that the method comprises enabling or disabling (150) one or more capabilities of a driver or application software according to the profile of capabilities.

Another example (e.g., example 28) relates to a previous example (e.g., one of the examples 23 to 27) or to any other example, further comprising that the method comprises obtaining (110) the profile of specified capabilities during a manufacturing process of manufacturing the computer system and enabling or disabling (150) the one or more capabilities of the computer system according to the profile of capabilities during the manufacturing process of manufacturing the computer system.

Another example (e.g., example 29) relates to a previous example (e.g., one of the examples 23 to 28) or to any other example, further comprising that the one or more capabilities include at least one of a capability related to a trusted execution environment, a capability related to remote management of the computer system, a capability related to trusted device setup, and a capability related to computer system security.

Another example (e.g., example 30) relates to a previous example (e.g., one of the examples 19 to 29) or to any other example, further comprising that the method comprises providing (140) the information on the computer system satisfying the profile of specified capabilities via a model-specific register of a processor of the computer system.

Another example (e.g., example 31) relates to a previous example (e.g., one of the examples 19 to 30) or to any other example, further comprising that the method comprises providing (140) the information on the computer system satisfying the profile of specified capabilities via a cryptographic certificate attesting that the computer system satisfies the profile of specified capabilities.

Another example (e.g., example 32) relates to a previous example (e.g., example 31) or to any other example, further comprising that the certificate is a certificate of a hardware root of trust certificate chain.

Another example (e.g., example 33) relates to a previous example (e.g., one of the examples 31 or 32) or to any other example, further comprising that the method comprises providing the cryptographic certificate to a remote entity.

Another example (e.g., example 34) relates to a computer system (100) to perform the method according to one of the examples 19 to 33 (or according to any other example).

Another example (e.g., example 35) relates to a non-transitory, computer-readable medium comprising a program code that, when the program code is executed on a processor, a computer, or a programmable hardware component, causes the processor, computer, or programmable hardware component to perform the method of one of the examples 19 to 33 (or according to any other example).

Another example (e.g., example 36) relates to a non-transitory machine-readable storage medium including program code, when executed, to cause a machine to perform the method of one of the examples 19 to 33 (or according to any other example).

Another example (e.g., example 37) relates to a computer program having a program code for performing the method of one of the examples 19 to 33 (or according to any other example) when the computer program is executed on a computer, a processor, or a programmable hardware component.

Another example (e.g., example 38) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a computer system, the apparatus comprising interface circuitry, machine-readable instructions, and processor circuitry to execute the machine-readable instructions to:
obtain a profile of specified capabilities of the computer system;
compare capabilities supported by the computer system with the profile of specified capabilities; and
provide information on the computer system satisfying the profile of specified capabilities if the capabilities supported by the computer system satisfy the profile of specified capabilities.

2. The apparatus according to claim 1, wherein the profile of specified capabilities is assigned to the computer system, during manufacturing of the computer system, by a vendor of the computer system.

3. The apparatus according to claim 1, wherein the profile of specified capabilities is specified for a computing platform, with the computer system being based on the computing platform if the capabilities supported by the computer system satisfy the profile of specified capabilities.

4. The apparatus according to claim 1, wherein the profile of specified capabilities specifies the capabilities required by a computer system to be allowed to advertise adherence with a computing platform brand.

5. The apparatus according to claim 1, wherein the processor circuitry is to execute the machine-readable instructions to enable or disable one or more capabilities of the computer system according to the profile of capabilities.

6. The apparatus according to claim 5, wherein the processor circuitry is to execute the machine-readable instructions to enable or disable one or more capabilities of a processor of the computer system according to the profile of capabilities.

7. The apparatus according to claim 6, wherein the processor circuitry is to execute the machine-readable instructions to enable or disable the one or more capabilities of the processor via a microcode of the processor.

8. The apparatus according to claim 5, wherein the processor circuitry is to execute the machine-readable instructions to enable or disable one or more capabilities of a firmware of the computer system according to the profile of capabilities.

9. The apparatus according to claim 5, wherein the processor circuitry is to execute the machine-readable instructions to enable or disable one or more capabilities of a driver or application software according to the profile of capabilities.

10. The apparatus according to claim 5, wherein the processor circuitry is to execute the machine-readable instructions to obtain the profile of specified capabilities during a manufacturing process of manufacturing the computer system, and to enable or disable the one or more capabilities of the computer system according to the profile of capabilities during the manufacturing process of manufacturing the computer system.

11. The apparatus according to claim 5, wherein the one or more capabilities include at least one of a capability related to a trusted execution environment, a capability related to remote management of the computer system, a capability related to trusted device setup, and a capability related to computer system security.

12. The apparatus according to claim 1, wherein the processor circuitry is to execute the machine-readable instructions to provide the information on the computer system satisfying the profile of specified capabilities via a model-specific register of a processor of the computer system.

13. The apparatus according to claim 1, wherein the processor circuitry is to execute the machine-readable instructions to provide the information on the computer system satisfying the profile of specified capabilities via a cryptographic certificate attesting that the computer system satisfies the profile of specified capabilities.

14. The apparatus according to claim 13, wherein the certificate is a certificate of a hardware root of trust certificate chain.

15. The apparatus according to claim 13, wherein the processor circuitry is to execute the machine-readable instructions to provide the cryptographic certificate to a remote entity.

16. A computer system comprising the apparatus according to claim 1.

17. A method for a computer system, the method comprising:
obtaining a profile of specified capabilities of the computer system;
comparing capabilities supported by the computer system with the profile of specified capabilities; and
providing information on the computer system satisfying the profile of specified capabilities if the capabilities supported by the computer system satisfy the profile of specified capabilities.

18. The method according to claim 17, wherein the profile of specified capabilities is assigned to the computer system, during manufacturing of the computer system, by a vendor of the computer system.

19. The method according to claim 17, wherein the profile of specified capabilities is specified for a computing platform, with the computer system being based on the computing platform if the capabilities supported by the computer system satisfy the profile of specified capabilities.

20. A non-transitory, computer-readable medium comprising a program code that, when the program code is executed on a processor, a computer, or a programmable hardware component, causes the processor, computer, or programmable hardware component to perform the method of claim 17.
